(19) United States
(12) Patent Application Publication
(10) Pub. No.: US 2018/0360075 A1
(43) Pub. Date: Dec. 20, 2018

(54) CAT FOOD ROLLS

(71) Applicant: Redbarn Pet Products, Inc., Long Beach, CA (US)

(72) Inventor: Steven Benjamin DOERR, Overland Park, KS (US)

(73) Assignee: Redbarn Pet Products, Inc., Long Beach, CA (US)

(21) Appl. No.: 16/008,904

(22) Filed: Jun. 14, 2018

Related U.S. Application Data
(60) Provisional application No. 62/520,034, filed on Jun. 15, 2017.

(51) Int. Cl. A23K 50/42; A23K 10/20; A23K 40/20

(52) U.S. Cl. CPC A23K 50/42; A23J 1/02; A23K 40/20; A23K 10/20

(57) ABSTRACT

Disclosed herein are cat food rolls compositions which include animal proteins, plant proteins and binding agents, and methods for making them. The methods include combining animal protein, plant protein and binding agent, and optionally one or more food grade additives to form a cat food roll composition and processing the composition to form a cat food roll product. The cat food roll product possesses improved shelf-stability and enhanced palatability.

### CROSS-REFERENCE TO RELATED APPLICATIONS

The present application claims the benefit of priority to U.S. Provisional Patent Application Ser. No. 62/520,034, filed on Jun. 15, 2017, the entire contents of which are hereby incorporated by reference.

### FIELD

The present technology relates in general to cat food products with high-shelf stability and methods for making and using the cat food product.

### BACKGROUND

Cats are obligate carnivores and require a diet with high amount of protein, moderate amounts of fat and minimal amounts of carbohydrates. The optimal diet for a cat is raw meat, although properly formulated cooked meat or grain-free canned diet are also conventional. The pet industry has provided a wide range of food products for cats over the years. These include dry foods, wet foods and vegetarian or vegan food. Most dry cat foods include protein from various meat sources such as meats, meat byproducts, poultry or poultry byproducts, fish meal, and other ingredients such as grain, grain byproducts, fiber sources, milk products, vitamins and mineral supplements, which are combined, extruded, and dried into bite-sized pieces. Wet canned foods include meat or meat by-product and about 75% water. Vegetarian foods are generally rich in plant based proteins and added nutritional supplements. Vegetarian and vegan food options do not provide the necessary nutrition that the carnivorous cat requires. Although dry cat food products are shelf stable, they are less palatable than wet foods. Wet cat food is palatable, but not very shelf-stable and adding preservatives to improve their stability only serves to diminish their palatability.

Several attempts have been made for improving the palatability and shelf-stability of cat food products. Some pet food manufacturers have developed products having flavor or palatability enhancers which are applied to the surface of dry cat foods to increase palatability. Others have designed wet food products having sugars, organic acids, enzymes, antimycotic or antimicrobial agents Yet others have proposed multi-meal sterilized packaging systems to improve shelf-stability. Despite several different approaches to enhance palatability and shelf-stability of cat food products, there is still a need for improvement. The present invention thus contemplates a palatable and nutritionally-balanced cat food product having improved shelf-stability.

### SUMMARY

In one embodiment, a palatable, shelf-stable cat food roll is provided, wherein the cat food roll includes about 5 wt % to about 90 wt % of an animal protein source; about 0 wt % to about 40 wt % of a plant protein source; about 5 wt % to about 50 wt % of a binding agent; and optionally one or more food grade additives selected from the group consisting of palatability enhancers, humectants, antioxidants, preservatives, fats, and combinations thereof. In some embodiments, a cat food roll product prepared from the composition, is provided.

In certain embodiments, the animal protein source is selected from the group consisting of meat protein, fish protein, egg protein and milk protein, and combinations thereof. In some embodiments, the animal protein source is selected from the group consisting of meat protein, fish protein, egg protein and milk protein, and combinations thereof. In some embodiments, the meat protein source is selected from the group consisting of beef liver, deboned chicken, chicken liver, chicken heart, and combinations thereof. In certain embodiments, the fish protein source is selected from the group consisting of mackerel, catfish, tuna, tilapia, mussel powder, fish protein powder, and combinations thereof. In some embodiments, the egg protein source is selected from spray dried eggs, frozen egg whites or a combination thereof. In some embodiments, the milk protein source includes cheese powder.

In certain embodiments, the plant protein source is selected from the group consisting of dehydrated peas, dehydrated carrots, dried spinach, dandelion greens, flax seeds, and combinations thereof. In some embodiments, the binding agent is selected from the group consisting of chickpeas, pea protein, pea flour, potato flakes, tapioca, and combinations thereof.

In one aspect, which is combinable with the above embodiments and aspects, the composition includes from about 15 wt % to about 85 wt % of animal protein source. In some embodiments, the composition includes from about 0.1 wt % to about 20 wt % of plant protein source. In some embodiments, the composition includes from about 5 wt % to about 40 wt % of binding agent.

In one aspect, which is combinable with the above embodiments and aspects, the composition comprises from about 35% to about 85% by weight of animal protein, about 0.2% to about 5% by weight of plant protein, and about 5% to about 35% by weight of binding agent. In one aspect, which is combinable with the above embodiments and aspects, the composition further includes about 1% to about 5% by weight of palatability enhancer, about 5% to about 30% by weight of sugar, about 0.01% to about 0.5% by weight of antioxidant, and about 0.1% to about 5% by weight of fat.

In certain embodiments, the palatability enhancer is selected from the group consisting of SPF C'Sens NCL Cat, SPF C'Sens 13L Pork Cat, SPF C'Sens 13-L Cat, SPF 9P 6446 Cat, SPF 11P Cat, AFB B29030, AFB CC716, AFB V13, tetrasodium pyrophosphate, chicken digest, bully digest, fish digest, and combinations thereof. In some embodiments, the humectant is selected from the group consisting of sugar, maltodextrin, honey, sorbitol and combinations thereof. In some embodiments, the antioxidant is selected from the group consisting of tocopherols, citric acid, lactic acid, and combinations thereof. In some embodiments, the fat is selected from the group consisting of chicken fat, vegetable oil, sunflower oil, and combinations thereof. In some embodiments, the preservative is selected from the group consisting of sodium tripolyphosphate, sodium polyphosphate, potassium tripolyphosphate, potassium polyphosphate, and combinations thereof.

In one aspect, which is combinable with the above embodiments and aspects, a method of making a cat food roll product is provided. The method includes combining one or more of animal protein, plant protein and binding agent, and optionally one or more food grade additives to form a cat food roll composition and processing the composition to form a cat food roll product. In some embodiments, the processing comprises forming the composition in to a desired shape; sealing the shaped composition; and heat processing the sealed composition for a period of time sufficient to cook the protein. In some embodiments, the method further includes comminuting the meat protein prior to combining it with the plant protein and binding agent.

In some embodiments of the method, the one or more food grade additives are selected from the group consisting of palatability enhancers, humectants, antioxidants, preservatives, fats, and combinations thereof.

In some embodiments, the forming comprises extruding the composition to a roll or shaping the composition in to a patty. In some embodiments, the sealing includes forming a hermetically sealed wrapping around the shaped composition.

In certain embodiments, the heat processing includes cooking the composition to an internal temperature of about 170° F. to about 212° F. In some embodiments, the heat processing includes heating the sealed composition in a water bath maintained at a temperature of about 180° F. to about 250° F. In some embodiments, the heat processing includes exposing the sealed composition to hot air until the composition reaches an internal temperature of about 170° F. to about 212° F.

In one aspect, which is combinable with the above embodiments and aspects, a cat food roll product prepared according to the described method is provided. In some embodiments, the cat food roll product is shelf stable for a period of about 12 months to about 24 months.

The foregoing summary is illustrative only and is not intended to be in any way limiting. In addition to the illustrative aspects, embodiments and features described above, further aspects, embodiments and features will become apparent by reference to the following drawings and the detailed description.

### BRIEF DESCRIPTION OF THE DRAWINGS

FIG. 1 is a photographic representation of an embodiment of the cat food roll product in the sausage form.

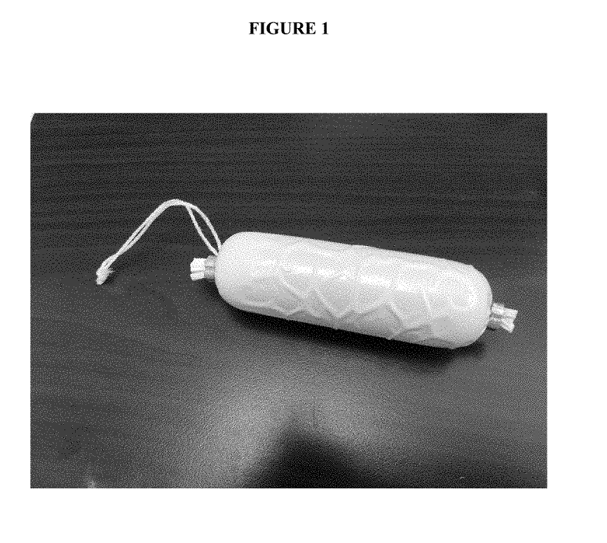

FIG. 2 is a photographic representation of an embodiment of the cat food roll product in the patties form.

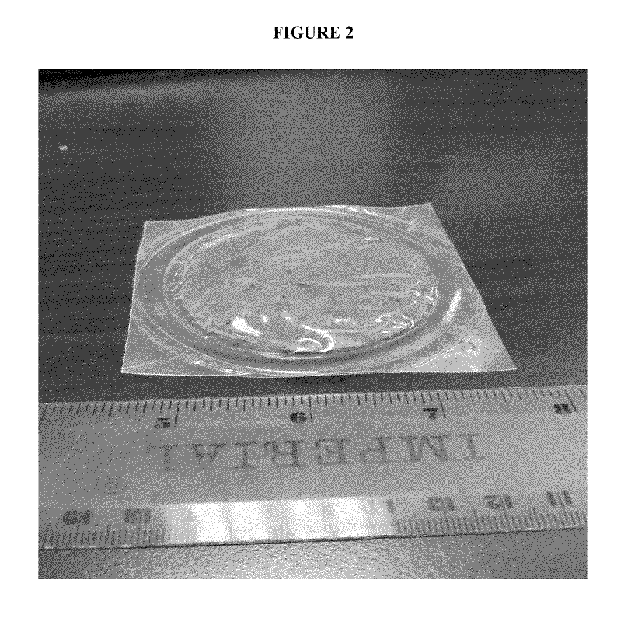

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). The description of the preferred embodiment as set forth herein, and as depicted in the drawings, is provided for illustrative purposes only.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The expression “comprising” means “including, but not limited to.” Thus, other non-mentioned substances, additives, carriers, or steps may be present. Unless otherwise specified, “a” or “an” means one or more.

As used herein, the term “and/or” includes any and all combinations of one or more of the associated listed items.

Unless otherwise indicated, all numbers expressing quantities of ingredients, reaction conditions, and so forth, used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques. The term “about” when used before a numerical designation, e.g., temperature, time, amount, and concentration, including range, indicates approximations which may vary by (+) or (−) 10%, 5% or 1%.

As used herein, the term “animal” is used in a general sense and means a human or other animal including, without limitation, avian, piscine, bovine, canine, gallinaceous, equine, feline, lupine, murine, ovine, and porcine animals, thus encompassing pets.

“Meat” as used herein includes any type of meat including livestock, poultry and seafood. Exemplary meats include chicken, turkey, duck, goose, fish, mollusks, shark, shellfish, beef, pork, ham, lamb, veal, venison, lamb, mutton, ostrich, bison, deer, elk, antelope, mink meat, kangaroo meat, horse, fox meat, fish meat, meat by-products, or a combination of two or more thereof.

Although the present disclosure exemplifies cat food, the invention can be adapted for use with other classes of pet animals.

“Cat food rolls” are products intended to be consumed by a cat and are primarily in the shape of a roll, but other shapes are also contemplated.

The terms “fat” and “oil” are used herein to mean edible fats and oils and are used herein interchangeably to include both except when indicated otherwise expressly or when it is apparent from the context that exclusively one or the other is intended.

As used herein, the term “palatable” or “palatability” refers to the eating quality of cat food roll products. For example, the palatable cat food roll will likely have an agreeable or pleasant taste upon consumption and possess an appetizing appearance, odor and texture.

The present invention provides a new combination of ingredients and design which makes it possible to produce a cat food roll product for consumption, which is shelf-stable, palatable, high quality and nutritionally balanced.

Many meat containing pet products such as sausage or chubs available in the market are simply not shelf-stable as they are perishable and affected by bacterial contamination or they have too many added preservatives which diminishes their palatability. Therefore, in one aspect, the present invention provides for techniques for preparing shelf-stable cat food products, which are also highly palatable and nutritionally balanced.

In one aspect, a palatable, shelf-stable cat food roll composition is provided, wherein the cat food includes proteins, carbohydrates, fat, fiber, vitamins, minerals and other components at sufficient dietary levels in order to maintain the overall health of the cat. In one embodiment, the cat food roll composition includes the cat food roll composition includes one or more protein source, a binding agent, a carbohydrate source, fat, ash, fiber and water. In one embodiment, one or an animal protein source, a plant protein source, and a binding agent.

The cat food roll composition, in one embodiment, includes a source of protein. The proteins may be any suitable protein such as animal proteins (e.g., meat proteins, fish proteins, egg proteins and milk proteins); vegetable proteins (e.g., pea protein, bean protein, soy protein, and wheat protein); protein premixes; mixtures of free amino acids; and the like, and combinations thereof. Suitable animal protein sources include, but are not limited to, fish, chicken, beef, egg, cheese, protein premix and the like, and combinations thereof. The protein source can be incorporated into the cat food roll compositions in the form of comminuted solid, dry powder, liquid, or a digest.

The cat food roll composition, in one embodiment, may include animal protein source. In some embodiments, the animal protein source includes meat proteins. Suitable meat proteins include, but are not limited to chicken, beef, duck, buffalo, venison, rabbit, veal, mutton, ham, turkey, goose, lamb, pork, and the like, or a combination of two or more thereof. In some embodiments, the meat includes chicken. In some embodiments, the meat includes beef. The meat proteins can be obtained from animal parts including meat, skin, organs, bones and blood. In some embodiments, the animal protein is obtained from free range chicken. In some embodiments, the animal protein includes one or more of chicken, chicken liver, chicken heart and beef liver. The chicken may include deboned chicken. The chicken may include mechanically deboned or separated chicken. In some embodiments, the animal protein includes chicken liver. In other embodiments, the animal protein includes chicken, mechanically deboned chicken, chicken liver, chicken heart, and the like, or a combination of two or more thereof. In some embodiments, the animal protein includes beef liver, chicken liver, chicken heart, and combinations thereof.

In some embodiments, the animal protein source includes fish protein source. Suitable sources of fish protein include, but are not limited to, tuna, catfish, mackerel, tilapia, cod, salmon, flounder, haddock, sole, sea bass, trout, mussels, clams, scallops, oysters, snails, squid, octopus, shrimp, crayfish, crabmeat, lobster, perch, shark, carp, swordfish, monkfish, snapper, eel, herring, anchovies, bluefish, sturgeon, whitefish, mahi mahi, mullet, pike, pollock, walleye, and the like, or a combination of two or more thereof. The fish may be fresh, canned or frozen. In some embodiments, the fish protein includes mackerel, catfish, tuna, tilapia, mussel powder, fish protein powder, and combinations thereof. In some embodiments, the animal protein includes mackerel. In other embodiments, the animal protein includes catfish. In some embodiments, the animal protein includes tuna. In some embodiments, the animal protein includes tilapia. In some embodiments, the animal protein includes mussel powder. In some embodiments, the animal protein includes tilapia. In some embodiments, the animal protein includes fish protein powder.

In some embodiments, the animal protein source includes egg protein source. Suitable sources of egg proteins include whole eggs, egg whites, and egg yolks, which may be utilized in various forms such as liquid, frozen, dried, reconstituted or concentrated. Exemplary egg proteins include, but are not limited to liquid whole egg, spray dried egg, frozen egg, freeze dried egg, concentrated egg, reconstituted freeze-dried egg, reconstituted spray dried egg, liquid egg white, frozen egg white, freeze dried egg white, concentrated egg whites, reconstituted freeze-dried egg whites, reconstituted spray dried egg whites, liquid egg yolk, frozen egg yolk, freeze dried egg yolk, concentrated egg yolk, reconstituted freeze-dried egg yolk, or reconstituted spray dried egg yolk, and the like, or a combination of two or more thereof. In some embodiments, the egg protein source includes spray dried eggs, frozen egg whites or a combination thereof. In some embodiments, the egg protein source includes spray dried eggs. In other embodiments, the egg protein source includes frozen egg whites.

In some embodiments, the animal protein includes milk protein source. Suitable sources of milk proteins include milk, cheese, butter, yoghurt, whey, buttermilk, cream, which may be utilized in various forms such as liquid, powder or concentrate. The milk may be obtained from various species of dairy animal, such as cow, buffalo, goat, sheep, yak, and the like. Exemplary milk proteins include, but are not limited to, cheese powder, milk powder, whey powder, casein salts, cream powder, buttermilk powder, whey concentrate, condensed milk, casein, milk protein, whey protein, milk solids, butter solids, milk fat, and the like, or a combination of two or more thereof. In some embodiments, the milk protein source includes cheese powder.

In one embodiment, the cat food roll compositions may include a meat protein or fish protein digest. The digest may be prepared by enzymatically treating the meat or fish protein source. In some embodiments, the protein sources such as chicken or fish are ground and added to an aqueous enzyme solution which is heated to a suitable temperature. The solution may then be agitated and held at a suitable temperature for a suitable period of time till the ground protein source is completely digested. The undigested portion can be removed by screening the solution on a mesh screen.

The cat food roll composition may include one or more of meat protein, fish protein, egg protein, milk proteins, protein digest, protein powder and protein premixes in an amount sufficient to provide the dietary levels of protein to the cat. The cat food roll composition may include between about 2 wt % and about 95% animal protein. In some embodiment, the cat food roll composition includes one or more animal protein in an amount of about 5 wt % to about 90 wt %, about 10 wt % to about 90 wt %, about 25 wt % to about 85 wt %, about 40 wt % to about 80 wt %, about 45 wt % to about 75 wt %, about 50 wt % to about 70 wt %, or about 55 wt % to about 65 wt %, of the total weight of the cat food roll composition, and ranges between any two of these values or less than any one of these values. In some embodiments, the cat food roll composition includes from about 5 wt % to about 90 wt % of animal protein. In some embodiments, the cat food roll composition includes from about 35 wt % to about 85 wt % of animal protein. In some embodiments, the cat food roll composition includes from about 45 wt % to about 60 wt % of animal protein. This may include one or more of about 35 wt % to about 55 wt % of meat protein, about 35 wt % to about 55 wt % of fish protein, about 1 wt % to about 10 wt % of egg protein, about 0.001 wt % to about 5 wt % of milk protein, and about 1 wt % to about 10 wt % of protein powder or premix.

The cat food roll composition, in one embodiment, may include one or more plant protein source. Protein can be isolated from any portion of the plant, including the roots, stems, leaves, flowers, or seeds. In some embodiments, the plant protein includes protein derived from grains, nuts, beans, legumes, cereals, grains, vegetables and seeds, including, but not limited to, peas such as, e.g., yellow peas, cowpeas, English peas, or green peas; beans such as, e.g., soybeans, fava beans, lima beans, kidney beans, garbanzo beans (chickpeas), mung beans, pinto beans, soybean; other legumes such as e.g., lentils, carob, mesquite, alfalfa, peanuts; cereals and grains such as e.g., maize, oats, rice, wheat, barley, rye, millet, sorghum, buckwheat, amaranth, quinoa; seeds such as e.g., flax seed, chia seed, hemp seed, sunflower seed, cottonseed, safflower seed, mustard, rapeseed, sesame seed; leafy green vegetables such as, e.g., spinach, dried spinach, dandelion greens, dandelion leaf, turnip greens, mustard greens, collard greens, kale, lettuce, chard, broccoli, or cabbage, cassava, spirulina, chlorella; other vegetables such as carrots, peas, celery, dehydrated carrots, dried celery, dehydrated peas, and the like, or a combination of two or more thereof. In some embodiments, the plant protein source includes dehydrated peas, dehydrated carrots, dried spinach, dandelion greens, flax seeds or a combination thereof. In some embodiments, the plant protein includes spinach, dandelion greens, flax seed or a combination thereof. In other embodiments, the plant protein source includes dehydrated peas, dehydrated carrots, dried spinach, or a combination thereof. In some embodiments, the plant protein includes flax seed.

The cat food roll composition according to the invention includes between 0.0 wt % and 40% plant protein. In some embodiment, the cat food roll composition includes one or more plant protein in an amount of about 0.001 wt % to about 30 wt %, 0.01 wt % to about 20 wt %, about 0.05 wt % to about 10 wt %, about 0.1 wt % to about 5 wt %, about 0.2 wt % to about 3.5 wt %, or about 0.5 wt % to about 2 wt %, of the total weight of the cat food roll composition, and ranges between any two of these values or less than any one of these values. In some embodiments, the cat food roll composition includes from about 0.1 wt % to about 20 wt % of plant protein. In some embodiments, the cat food roll composition includes from about 0.2 wt % to about 5 wt % of plant protein. In some embodiments, the cat food roll composition includes from about 0.2 wt % to about 3.5 wt % of plant protein. In some embodiments, the cat food roll composition includes from about 0.2 wt % to about 2 wt % of plant protein.

The cat food roll composition, in one embodiment, may include one or more binding agent to bind together the various components. The binding agent may be such that it provides high protein content along with binding action. The binding agent may additionally provide moisturizing, leavening, or emulsifying properties Exemplary binding agents include, but are not limited to chickpeas (garbanzo beans), pea protein, pea flour (e.g., yellow pea flour), potato flakes, onion flakes, tapioca, vegetable protein powder, fish protein, soya protein, almond flour, corn flour, rice flour, pectin, albumen, whole eggs, egg whites, and the like, or a combination of two or more thereof. In some embodiments the binding agent includes chickpeas, pea protein, pea flour, potato flakes, tapioca, or a combination thereof. In other embodiments, the binding agent includes pea flour and pea protein. In some embodiments, the binding agent includes chickpeas. In other embodiments, the binding agent includes pea protein. In some embodiments, the binding agent includes pea flour.

The cat food roll composition one or more binding agents in an amount sufficient to bind the components in to a homogeneous mixture suitable for forming the product. The cat food roll composition according to the invention includes between 0.05 wt % and 50% plant protein. The cat food roll composition may include one or more binding agent in an amount of about 0.01 wt % to about 40 wt %, about 0.1 wt % to about 30 wt %, about 1 wt % to about 35 wt %, about 5 wt % to about 30 wt %, about 7 wt % to about 20 wt %, or about 10 wt % to about 15 wt %, of the total weight of the cat food roll composition, and ranges between any two of these values or less than any one of these values. In some embodiments, the cat food roll composition includes from about 5 wt % to about 50 wt % of a binding agent. In some embodiments, the cat food roll composition includes from about 5 wt % to about 40 wt % of a binding agent. In other embodiments, the cat food roll composition includes from about 7 wt % to about 35 wt % of a binding agent. In some embodiments, the cat food roll composition includes from about 10 to about 20 wt % of a binding agent.

In one aspect, a cat food roll composition is provided, wherein the composition includes about 35% to about 85% by weight of animal protein, about 0.2% to about 5% by weight of plant protein, and about 5% to about 35% by weight of binding agent. In some embodiments, a cat food roll is provided, which includes about 35% to about 85% by weight of meat protein, about 0.2% to about 5% by weight of plant protein, and about 5% to about 35% by weight of binding agent. In other embodiments, a cat food roll is provided, which includes about 35% to about 85% by weight of fish protein, about 0.2% to about 5% by weight of plant protein, and about 5% to about 35% by weight of binding agent.

In one embodiment, a cat food roll composition is provided, which includes about 40% to about 55% by weight of fish protein, about 5% to about 10% by weight of egg protein, about 0.2% to about 5% by weight of plant protein, and about 5% to about 15% by weight of binding agent. In some embodiments, a cat food roll is provided, which includes about 40% to about 55% by weight of fish protein, about 5% to about 10% by weight of dried egg spray, about 0.2% to about 5% by weight of dried spinach, and about 5% to about 15% by weight of pea protein.

In one embodiment, a cat food roll composition is provided, which includes about 40% to about 65% by weight of meat protein, about 5% to about 10% by weight of egg protein, about 0.1% to about 5% by weight of plant protein, and about 5% to about 20% by weight of binding agent. In some embodiments, a cat food roll is provided, which includes two or more of about 10% to about 30% by weight of beef liver, about 10% to about 30% by weight of chicken liver and heart, about 10% to about 30% by weight of MD chicken, about 1% to about 5% by weight of bully digest, about 1% to about 5% by weight of chicken digest, about 5% to about 10% by weight of dried egg spray, about 5% to about 10% by weight of frozen egg white, about 0.1% to about 2% by weight of dried spinach, about 0.1% to about 2% by weight of dehydrated peas, about 0.1% to about 2% by weight of dehydrated carrots, about 5% to about 20% by weight of pea flour, about 5% to about 20% by weight of pea protein and about 5% to about 20% by weight of chickpeas.

In addition to the animal protein, plant protein and binding agent, the cat food roll compositions may further include additives known in the art and listed herein. Suitable additives include, but are not limited to, palatability enhancers, nutritional aids, preservatives, humectants, antioxidants, thickeners, fats, oils, water, emulsifiers, acidifiers, heat settable agents, adhesion agents, colorants, and the like, or a combination of two or more thereof. In one embodiment, the additives are food grade additives selected from palatability enhancers, fats, antioxidants, nutritional aids or mixtures thereof. The amount of additives is based on the total weight of the cat food roll composition, unless mentioned otherwise.

In some embodiments, the cat food roll composition may include one or more palatability enhancers. Suitable palatability enhancers include commercially available ones such as e.g., SPF Super Premium palatability enhancer intended for wet pet food applications. Exemplary commercial palatability enhancers include SPF C'Sens NCL Cat, SPF C'Sens 13L Pork Cat, SPF C'Sens 13-L Cat, SPF 9P 6446 Cat, SPF 11P Cat, AFB B29030, AFB CC716, AFB V13, and the like, or a combination of two or more thereof. In another embodiment, the cat food roll composition may include palatability enhancer in the form of chicken powder, chicken digest, fish powder, fish digest, bully powder, bully digest, chicken liver digest, chicken viscera digest, tetrasodium pyrophosphate, sodium acid pyrophosphate, tetrapotassium pyrophosphate, potassium pyrophosphate salts, and the like, or a combination of two or more thereof. In some embodiments, the palatability enhancer includes one or more of chicken digest, bully digest, fish digest. In some embodiments, the palatability enhancer includes tetrasodium pyrophosphate. In other embodiments, the palatability enhancer includes SPF C'Sens NCL Cat, SPF C'Sens 13L Pork Cat, SPF C'Sens 13-L Cat, SPF 9P 6446 Cat, SPF 11P Cat, AFB B29030, AFB CC716, AFB V13 or a combination of two or more thereof. In some embodiments, the palatability enhancer includes SPF C'Sens NCL Cat, SPF C'Sens 13L Pork Cat, SPF C'Sens 13-L Cat, SPF 9P 6446 Cat, SPF 11P Cat, AFB B29030, AFB CC716, AFB V13, tetrasodium pyrophosphate, chicken digest, bully digest, fish digest, chicken liver digest, chicken viscera digest, or combinations thereof.

The palatability enhancer may be included in an amount of about 0.001% to 30%, based on the total weight of the cat food roll composition. In some embodiment, the cat food roll composition includes one or more palatability enhancers in the amount of about 0.001 wt %, about 0.01 wt %, about 0.1 wt %, about 0.2 wt %, about 0.25 wt %, about 0.5 wt %, about 1 wt %, about 1.5 wt %, about 2 wt %, about 2.5 wt %, about 3 wt %, about 3.5 wt %, about 4 wt %, about 5 wt %, about 7.5 wt %, about 10 wt %, about 20 wt %, of the total weight of the cat food roll composition, and ranges between any two of these values or less than any one of these values. In some embodiments, the cat food roll composition includes from about 0.01 wt % to about 0.5 wt % of a palatability enhancer. In some embodiments, the cat food roll composition includes from about 1 wt % to about 5 wt % of a palatability enhancer.

In some embodiments, the cat food roll composition may include a suitable humectant known in the art, including, but are not limited to, sugar, glycerin, sucrose, dextrose, fructose, corn syrup, betaine, polyols, molasses, sorghum syrup, fruit syrups, maltodextrin, rice syrup, high fructose corn syrup, honey, glycerol, sorbitol, maltitol, whey, propylene glycol, corn syrup solids, aloe vera, and the like, and mixtures thereof. In some embodiments, the humectant includes maltodextrin. In some embodiments, the humectant includes sugar. In some embodiments, the humectant includes sorbitol. In some embodiments, the humectant includes sugar, maltodextrin, honey, sorbitol, or combinations thereof.

The cat food roll composition may include a humectant, such as in an amount of about 0.1 wt % to about 40 wt %, about 51 wt % to about 30 wt %, about 5 wt % to about 35 wt %, about 7 wt % to about 30 wt %, about 10 wt % to about 20 wt %, or about 14 wt % to about 18 wt %, of the total weight of the cat food roll composition, and ranges between any two of these values or less than any one of these values. In some embodiments, the cat food roll composition includes from about 5 wt % to about 30 wt % of a humectant. In other embodiments, the cat food roll composition includes from about 10 wt % to about 20 wt % of humectant.

In some embodiments, the cat food roll composition includes an antioxidant. Suitable antioxidants are known in the art and include, but are not limited to tocopherols such as α-, β-, γ- and δ-tocopherol, citric acid, lactic acid, ascorbic acid, sodium or calcium ascorbate, citrus oils, fumaric acid, malic acid, sodium ascorbyl palmitate, butylated hydroxyanisol (BHA), butylated hydroxytoluene (BHT), and tertiary butyl hydroquinone (TBHQ), rosemary extract, flax seed or oil, propyl gallate and other food grade antioxidants, and the like, or a combination of two or more thereof. In some embodiments, the antioxidant includes tocopherols, citric acid, lactic acid, or combinations thereof. In some embodiments, the antioxidant includes mixed tocopherols. In some embodiments, the antioxidant includes citric acid. In some embodiments, the antioxidant includes lactic acid.

The cat food roll composition may include one or more antioxidants in the amount of about 0.001 wt %, about 0.005 wt %, about 0.008 wt %, about 0.01 wt %, about 0.02 wt %, about 0.03 wt %, about 0.04 wt %, about 0.5 wt %, about 0.8 wt %, 1.0 wt %, about 2.0 wt %, about 5.0 wt %, of the total weight of the cat food roll composition, and ranges between and including any two of these values or less than any one of these values. In some embodiments, the cat food roll composition includes from amount of about 0.01 to about 0.5 percent by weight of an antioxidant. In another embodiment, the cat food roll composition includes from about 0.01 to about 0.2 percent by weight of an antioxidant.

The preservatives utilized in the present compositions and methods include any suitable preservatives known in the art, including food grade preservatives. The preservatives may function as mold inhibitors or antioxidants. Suitable preservatives include, but are not limited to, sodium tripolyphosphate, sodium polyphosphate, potassium tripolyphosphate, potassium polyphosphate, sodium benzoate, calcium benzoate, potassium benzoate, potassium sorbate, sodium sorbate, calcium sorbate, sodium acetate, calcium acetate, sodium diacetate, calcium diacetate, sodium propionate, calcium propionate, potassium propionate, citric acid, lactic acid, sorbic acid, ascorbic acid, propionic acid, paraaminobenzoic acid esters (parabens), smoke, liquid smoke, cultured whey, cultured sugar, and the like, or a combination of two or more thereof. In some embodiments, the preservative includes sodium tripolyphosphate sodium polyphosphate, potassium tripolyphosphate, potassium polyphosphate, or combinations thereof.

The cat food roll compositions may include one or more preservatives in the amount of about 0.001 wt %, about 0.005 wt %, about 0.01 wt %, about 0.05 wt %, about 0.1 wt %, about 0.5 wt %, about 1.0 wt %, about 2.0 wt %, about 3.0 wt %, 5.0 wt %, about 10.0 wt %, about 20.0 wt %, of the total weight of the cat food roll composition, of the total weight of the cat food roll composition, and ranges between and including any two of these values or less than any one of these values. In some embodiments, the cat food roll composition includes from about 0.01 wt to about 0.1 wt % of a preservative. In another embodiment, the cat food roll composition includes from about 0.1 wt % to about 0.5 wt % of a preservative.

The cat food roll composition may include fats (oils). Suitable fats include, but are not limited to fats that are derived from animal, plant, marine sources, or that are produced by animals and plants, such as animal fats, marine oils and plant oils. Suitable sources of plant oils which are available in large quantities include, but are not limited to, canola oil, soybean oil, corn oil, olive oil, sunflower oil, linseed oil, palm oil, safflower oil, and the like, or combinations thereof and by-products thereof. Suitable sources of animal fats include, but are not limited to, tallow, lard, poultry fat, and the like, or combinations thereof and by-products thereof. Suitable sources of marine oils include, but are not limited to, tuna oil, sardine oil, salmon oil, anchovy oil, fish oil and the like, or combinations thereof and by-products thereof. In some embodiments, the fat includes chicken fat, vegetable oil, olive oil, sunflower oil, or combinations thereof. In some embodiments, the fat includes chicken fat. In some embodiments, the fat includes vegetable oil. In some embodiments, the fat includes sunflower oil. In some embodiments, the fat includes olive oil.

In some embodiment, the cat food roll composition includes one or more fat in an amount of about 0.01 wt %, about 0.1 wt %, about 0.25 wt %, about 0.5 wt %, about 1.0 wt %, about 1.5 wt %, about 2.0 wt %, about 2.5 wt %, about 3.0 wt %, about 3.5 wt %, about 4.0 wt %, about 5.0 wt %, of the total weight of the cat food roll composition, and ranges between any two of these values or less than any one of these values. In some embodiments, the cat food roll composition includes from about 0.1 to about 5 wt % of fat. In some embodiments, the cat food roll composition includes from about 0.5 wt % to about 2 wt % of vegetable oil. In some embodiments, the cat food roll composition includes from about 0.5 wt % to about 2 wt % of sunflower oil.

In some embodiments, the cat food roll composition may include a nutritional aid such as vitamins, minerals, enzymes, probiotics, super foods, phytonutrients, taurine, nutritional yeast (e.g., brewer's yeast), animal fats (e.g., chicken fat, beef fat), lecithin, chicken cartilage, chondroitin, hemp seeds, flax seeds, chia, spirulina, wheatgrass, cinnamon, turmeric, dehydrated fruits and vegetables (e.g., carrots, peas, beetroot, broccoli etc.), fruits with antioxidant and other benefits (e.g., blueberries, cranberries, goji, pomegranate etc.); and the like, and mixtures thereof. Exemplary nutritional aids may include, but are not limited to, calcium carbonate, dicalcium phosphate, potassium chloride, sodium chloride, choline chloride, taurine, zinc oxide, ferrous sulphate, vitamin E, vitamin A, vitamin B12, vitamin D3, riboflavin, niacin, calcium pantothenate, biotin, thiamin mononitrate, copper sulphate, folic acid, pyroxidine hydrochloride, calcium iodate and the menadione sodium bisulphite complex (a source of vitamin K activity), green lip mussel, dandelion root or greens, inulin, carnitine, L-threonine, green tea extract, and the like or combinations thereof. In some embodiments, the nutritional aid is taurine. In some embodiments, the nutritional aid is green lip mussel.

The cat food roll compositions may include one or more nutritional aid in the amount of about 0.0001 wt %, about 0.0005 wt %, about 0.001 wt %, about 0.005 wt %, about 0.01 wt %, about 0.05 wt %, about 0.1 wt %, about 0.5 wt %, about 1.0 wt %, 3.0 wt %, about 5.0 wt %, about 10.0 wt %, of the total weight of the cat food roll composition, of the total weight of the cat food roll composition, and ranges between and including any two of these values or less than any one of these values. In some embodiments, the cat food roll composition includes from about 0.0001 wt % to about 0.1 wt % of a nutritional aid. In another embodiment, the cat food roll composition includes from about 0.0001 wt % to about 0.5 wt % of a nutritional aid.

In some embodiments, the cat food roll composition may include a flavoring agent. Suitable flavoring agents include, but are not limited to, liquid smoke, anchovies, enzyme hydrolyzed meats and fish, polyols, amino acids and their corresponding salts, polyamino acids and their corresponding salts, sugar acids and their corresponding salts, organic acids, inorganic acids, organic salts, inorganic salts, sea salt, sugar, sweeteners, bitter compounds, flavorants, astringent compounds, polymers, proteins or protein hydrolysates, flavonoids, alcohols, synthetic sweeteners, and the like, or a combination of two or more thereof. Suitable sweeteners include, but are not limited to xylose, glucose, fructose, arabinose, ribose, rhamnose, starch hydrolysates, and the like, or a combination of two or more thereof. In some embodiments, the cat food roll composition includes salt. In some embodiments, the cat food roll composition includes xylose. In some embodiments, the cat food roll composition includes enzyme hydrolyzed meats and fish. In some embodiments, the cat food roll composition includes liquid smoke. In some embodiments, the cat food roll composition includes anchovy paste.

In some embodiments, the cat food roll composition includes one or more flavoring agents in an amount of about 0.01 wt %, about 0.1 wt %, about 0.25 wt %, about 0.5 wt %, about 1.0 wt %, about 1.5 wt %, about 2.0 wt %, about 2.5 wt %, about 3.0 wt %, about 3.5 wt %, about 4.0 wt %, about 5.0 wt %, about 7.0 wt %, about 10.0 wt %, of the total weight of the cat food roll composition, and ranges between any two of these values or less than any one of these values. In some embodiments, the cat food roll composition includes from about 0.01 to about 5 wt % of flavoring agents. In other embodiments, the cat food roll composition includes from about 0.01 to about 2 wt % of flavoring agents.

The cat food roll composition may contain added water in the amount of about 0.001 wt %, about 0.01 wt %, about 0.05 wt %, about 0.1 wt %, about 0.5 wt %, about 1.0 wt %, about 5.0 wt %, about 10.0 wt %, of the total weight of the cat food roll composition, and ranges between and including any two of these values or less than any one of these values. In some embodiments, the cat food roll composition includes from about 0.01 wt % to about 2 wt % of water. In another embodiment, the cat food roll composition includes from about 0.5 to about 1.2 percent by weight of water.

In one aspect, a cat food roll composition is provided, wherein the composition includes about 35% to about 85% by weight of animal protein, about 0.2% to about 5% by weight of plant protein, about 5% to about 35% by weight of binding agent, about 1% to about 5% by weight of palatability enhancer, about 5% to about 30% by weight of sugar, about 0.01% to about 0.5% by weight of antioxidant, and about 0.1% to about 5% by weight of fat.

Thus in one aspect, the invention provides a cat food roll composition composed of animal proteins, plant proteins, binding agents and additives, which has improved shelf-stable, quality, palatability and nutritional balance. The cat food roll composition may further be formed into a suitable size and shape before or after cooking to obtain a cat food roll product. For example, the composition may be formed into sausages, rolls, patties, discs, cubes, sheets, blocks, balls, strips, sticks, cylinders, pyramids, slices or any other shape. In some embodiments, the composition is formed in to rolls. In other embodiments, the composition is formed in to patties. In some embodiments, the composition is formed in to chubs.

In one aspect, provided is a cat food roll product prepared from the cat food roll composition described herein. The cat food roll provides improved palatability and imparts a unique shelf-stability to the cat food roll product. The cat food roll product described herein is distinct from other cat food rolls known in the art in that the cat food roll has enhanced shelf-stability, is palatable, and provides a cat food roll which is nutritionally balanced for cat consumption. Unlike many tinned fish and meat based food products available for cats, the cat food roll product of the present invention does not degrade immediately upon exposure to atmospheric conditions. Unlike other meat or fish containing cat food products, the cat food rolls described herein have improved shelf-stability, and do not require special storage and transport conditions.

In one aspect, a method of making a cat food roll product is provided. The method includes combining animal protein, plant protein and binding agent, and optionally one or more food grade additives to form a cat food roll composition and processing the composition to form a sealed cooked cat food roll product.

In another aspect a method of making cat food roll product is provided, wherein the method includes forming a mix containing uncooked comminuted animal protein, a comminuted plant protein and a binding agent; shaping the mix; sealing the shaped mix; and heat processing the shaped mix so as to set the protein of the animal and plant protein and from a matrix binding it.

Suitable animal proteins, plant proteins and binding agents and cat food roll products are as described herein. In some embodiments, the animal protein includes one or more of chicken, chicken liver, chicken heart, beef liver, tuna, catfish, mackerel, tilapia, liquid eggs, spray dried eggs, frozen egg whites and cheese powder. In some embodiments, the animal protein includes meat proteins such as chicken, beef and the like. In some embodiments, the animal protein includes fish proteins such as tuna, catfish, mackerel, and tilapia. In some embodiments, the animal protein includes egg proteins such as liquid eggs, spray dried eggs, frozen egg whites. In some embodiments, the animal protein includes milk proteins such as cheese powder.

In some embodiments, the animal protein, such as meat or fish, is appropriately sized so as to achieve a smooth and homogeneous cat food roll. In some embodiments, the animal proteins such as meat proteins and fish proteins may optionally be deboned prior to being appropriately sized so as to achieve a desired protein size for the final product. Suitable manual or mechanical methods known in the art can be utilized to size the animal protein prior to incorporating it in to the cat food roll. For example, in one embodiment the animal protein is chopped, ground or minced to a suitable size using suitable equipment such as meat grinder, bowl chopper, mincer, dicer, food processor, cutter, commitrol, and the like or combinations thereof. In another embodiment, the animal protein are ground using suitable equipment to achieve the desired size and texture so that the animal protein can be formulated into a made homogeneous cat food roll. In some embodiments, the animal proteins may be incorporated in liquid form. In some embodiments, the animal proteins may be incorporated in powdered form.

Once the palatable animal protein have been reduced to a homogeneous mixture having a suitable particle size, various food grade additives such as palatability enhancers, humectants, antioxidants, preservatives, fats or mixtures thereof may be incorporated in to the cat food roll composition. In addition, other components such as flavoring agents, vitamins, minerals or nutritional aids, water, coloring agents, and the like, or mixtures thereof can be incorporated into this cat food roll composition. These additives may be added during the preparation and processing of the animal protein, during the grinding of the protein mixture or during or after the addition of the binding agent. These additives can be blended together or added one by one to the cat food roll composition.

In one embodiment, the method further includes incorporating food grade additives selected from palatability enhancers, fats, oils, antioxidants, nutritional aids or mixtures thereof. In addition, other components such as flavoring agents, vitamins, minerals or nutritional aids, water, coloring agents, and the like, or mixtures thereof can be incorporated into the cat food roll composition. Suitable additives are as described herein. These additives may be added during the preparation and processing of the animal protein, during the grinding of the protein mixture or during or after the addition of the binding agent. These additives can be blended together or added one by one to the cat food roll composition. In some embodiments, the additives are incorporated in to the animal protein, plant protein and binding agent mixture

In some embodiments the cat food roll composition formed by combining the various proteins, binding agents and additives is subjected to suitable processing steps to form a sealed cooked cat food roll product. In some embodiments, the processing may include forming the composition in to a desired shape; sealing the shaped composition; and heat processing the sealed composition for a period of time sufficient to cook the protein. These steps may be conducted in any desired sequence.

The composition may be formed into any suitable shape or size as desired depending on its final application and use. In some embodiments, the composition is shaped into rolls. In other embodiments, the composition is shaped into sausages. In other embodiments, the composition is shaped into chubs. In some embodiments, the composition is shaped into patties. In some embodiments, the composition is shaped into discs. In some embodiments, the composition is shaped into nuggets. In some embodiments, the composition is shaped into slices. In some embodiments, the composition is shaped into balls. Various shaping methods are known in the art. In some embodiments, the composition may be stuffed in to appropriately sized casings to obtain the desired shape and size. In other embodiments, the composition may be rolled to obtain the desired shape and size and sealed. n some embodiments, the composition may be extruded to form a roll. In some embodiments, the composition may be shaped in to a patty.

In some embodiments, the method further includes wrapping and sealing the cat food roll composition. The cat food roll composition, prior or after being formed in to a desired shape, may be wrapped and sealed using suitable materials, methods and apparatus known in the art. For example, the methods may include arranging a sealant material about the cat food roll before, during or after cooking the composition. In some embodiments, the cat food roll may be placed in a suitable sealant material and sealed using methods including, but not limited to, vacuum sealing, pressure sealing, thermal sealing, induction sealing, non-hermetic sealing, hermetic sealing, and the like or combinations thereof. Suitable sealant materials may include polymer films, polymer casings, polymer containers, polymer-coated papers, metal foils, biodegradable materials, edible materials, and the like or combinations thereof. In some embodiments, the composition is extruded in to a casing material and the casing material may be sealed using the methods described above. In some embodiments, the sealing includes forming a hermetically sealed wrapping or container around each individual cat food roll product or a plurality of cat food roll products. In some embodiments, the method includes hermitically sealing the cat food roll product in a package. In some embodiments, the compositions may be formed in to patties and hermetically sealed in a sealant material. In some embodiments, the compositions may be formed in to sausages and hermetically sealed in a sealant material. In some embodiments, the compositions may be formed in to rolls and hermetically sealed in a sealant material.

Suitable sealant materials may include any suitable material which can withstand the heat processing temperature and is inert to the composition. Exemplary sealant materials may include polymer films, edible casings, polymer casings, and polymer containers.

The cat food roll composition may be subjected to heat processing at a suitable temperature and for a period of time sufficient to cook the protein in the composition. The composition may be cooked by heating in a hot water bath, hot steam, hot air, hot water sprays, microwave, sous-vide, and the like or combinations thereof. In some embodiments, the method includes heat processing the cat food roll composition by heating in a hot water bath. In other embodiments, the method includes heat processing the cat food roll composition by exposing it to steam. In some embodiments, the method includes heat processing the cat food roll composition by exposing it to hot air. In some embodiments, the method includes heat processing the cat food roll composition sous-vide.

The cat food roll composition may be heat processed at the desired temperature for a desired time using techniques described above. The cat food roll composition may be partially or fully cooked or cooked at a suitable temperature. The temperature and time for cooking the composition will depend on the type, nature and amount of raw meat, fish, plant protein or binding agents to be cooked. For example fish meat may be cooked at relatively lower temperatures than beef. In some embodiments, the cooking of the cat food roll composition is conducted at a suitable temperature, e.g., from about 100° F. to about 130° F., about 110° F. to about 150° F., about 120° F. to about 180° F., or about 130° F. to about 200° F., and ranges between and including any two of these values. In some embodiments, the cat food roll composition is cooked in a water bath at a temperature of about 180° F. to about 250° F. In some embodiments, the cat food roll composition is cooked by exposing it hot air at a temperature of about 180° F. to about 250° F. In some embodiments, the cat food roll composition is cooked till the internal temperature of the product is about 170° F. to about 212° F.

In some embodiments, the cooking is done in stages. For example, in one embodiment, the meat fraction or the fish fraction is heated while mixing to a point slightly below the coagulation point of the protein. The temperature may then be raised slowly to begin denaturation of the protein. The temperature may be held at denaturation conditions until the denaturization level of the meat or fish is about 55% to about 95%. The plant proteins and binding agent and additives may then be added and further heat processed to cook all the components. Alternatively, the animal protein, plant protein, binding agent and additives may all be mixed and heat processed by slowly raising the temperature until the composition registers an internal temperature of about 170° F. to about 212° F.

The sealed and cooked cat food roll product may then be cooled to a suitable temperature. For example the cat food roll product may be cooled to a temperature of about 50° F. to about 150° F. The cooling may be done slowly or rapidly with the aid of suitable methods and devices. For example, once the cooking step is completed, cooling can be done through air drying, heat exchangers or through direct injection of a cooling gas such as nitrogen. Alternatively, the cat food roll product in casings or packages may be rapidly cooled by submerging them in or spraying them with ice water or by refrigeration. The cooling time may vary depending on the size and type of components.

The sealed and cooked cat food roll product may be subjected to further processing to sterilize the product using suitable methods known in the art. For example, the cat food roll product may be subjected to thermal sterilization, acidification, pasteurization, irradiation (e.g., microwave, high-frequency, ultraviolet), and the like or combinations thereof.

In one embodiment, a shelf stable cat food roll product obtained using the compositions and methods described herein is provided. A product has shelf stability when it is safe for consumption and maintains an acceptable quality when stored at room temperature. Some of the factors which contribute to the deterioration of foods include microbial, enzymatic, chemical and physical factors. In some embodiments, the cat food roll product is more shelf-stable compared to other analogous products known in the art.

Those skilled in the art will understand that a wide range of product textures and taste can be achieved simply by slight modifications of the basic process. For example, a robust roll product can be achieved by not overcooking the meat or fish, using a blend of different types of meat or fish ingredients, or by reducing the overall fat level in the total formulation. A more fragile product can be achieved by increasing the percentage of the cooked meat or fish, maintaining a coarser grind, or formulating it to include a higher fat percentage.

In some embodiments, the method further includes packaging the cat food roll product using suitable packaging methods known in the art using suitable packaging materials. As used herein, the term “packaging material” means any component of packaging in which cat food roll product is contained. Packaging materials include, for example, thermoplastic packaging films and foils, casings and wrapping or bags formed therefrom; coated or uncoated paper webs and sheets as well as bags or cardboard boxes; thermoformed punnets; wax or film applied directly to the product or to a container; multilayer packaging constructions; printed packaging, embossed indicia, labels placed on or in packaging or on product, adhesives used to close or seal packaging or adhere labels and the like thereto; ink printed directly on product, directly on packaging, or on a label that is then adhered to packaging. In some embodiments, the product is packaged in to edible casings, e.g., collagen casings. In some embodiments, the product is individually packed in plastic bags and then collectively packed in bulk boxes. The packaged product can be stored or transported for commercial distribution and sale.

The present compositions and methods improve the shelf-stability of the cat food roll product. In some embodiments, the shelf-stability of the cat food roll product is improved as compared to analogous products not containing the components included in the compositions described herein. In some embodiments, the shelf-stability of the cat food roll product is improved as compared to analogous products not containing the protein components and/or the binding agents described herein. In some embodiments, the shelf-stability of the cat food roll product is improved as compared to an analogous products not prepared by the methods described herein.

The present compositions and methods provide products which have improved resistance to microbial growth or activity, with minimal changes to other characteristics such as flavor, texture, aroma, and appearance. The cat food roll products described herein have a stable moisture content which provides good microbial stability for a prolonged period of time. In some embodiments, the cat food roll product exhibits no significant change in microbial on storage for a period of about 6 months. In some embodiments, the cat food roll product exhibits no significant change in microbial growth on storage for a period of about 12 months. In some embodiments, the cat food roll product exhibits no significant change in microbial growth on storage for a period of about 24 months. In some embodiments, the cat food roll product exhibits no significant change in microbial growth on storage for a period of about 36 months. The cat food roll product is shelf-stable for a period of about 3 months, about 6 months, about 9 months, about 12 months, about 15 months, about 18 months, about 21 months, about 24 months, about 27 months, about 30 months, about 36 months, about 42 months, or about 60 months, and ranges between and including any two of these values. In some embodiments, the cat food roll product is shelf stable for a period of about 6 months to about 24 months. In some embodiments, the cat food roll product is shelf stable for a period of about 12 months to about 24 months.

In some embodiments, the cat food roll product maintains its integrity and natural characteristics over a long period of time and is resistant to degradation and decay. In one embodiment, the cat food roll product retains about 80%, about 90% or about 100% of the initial dimensions over a period of about 24-36 months. In some embodiments, the cat food roll product retains the dimensionally stable indefinitely. In some embodiments, the cat food roll product remains resistant to degradation, molding and decay for over 12 months. In some embodiments, the cat food roll product remains resistant to degradation, molding and decay for over 24 months. In some embodiments, the cat food roll product remains resistant to degradation, molding and decay for over 36 months. In some embodiments, the cat food roll product remains resistant to degradation, molding and decay for about 6 to about 30 months. In some embodiments, the cat food roll product remains resistant to degradation, molding and decay for about 12 to about 24 months.

In some embodiments, the shelf-stability of said cat food roll product is improved by about 1% to about 10%, about 10% to about 20%, about 20% to about 30%, about 30% to about 40%, about 40% to about 50%, about 50% to about 60%, about 60% to about 70%, about 70% to about 80%, about 80% to about 90%, about 90% to about 100% and ranges between and including any two of these values, compared to analogous products not containing the components included in the compositions described herein and/or analogous products not prepared by the methods described herein.

In some embodiments, the cat food roll products have improved structure, texture, flavor or color compared to analogous products. In some embodiments, the cat food roll products have low shrinkage on storage than analogous products. The low shrinkage of the cat food roll products results in good storage stability and eliminates the need for storage and transportation of the product under controlled conditions. In some embodiments, the cat food roll product exhibits no significant change in product density on storage for a period of about 6 months. In some embodiments, the cat food roll product exhibits no significant change in product density on storage for a period of about 12 months. In some embodiments, the cat food roll product exhibits no significant change in product density on storage for a period of about 24 months.

The present compositions and methods improve the texture and integrity and provide a palatable, shelf-stable cat food roll product. In some embodiments, the cat food roll products retain their shelf-stability, structure and integrity for a longer period of time as compared to an analogous composition not prepared by the methods described herein. In some embodiments, a cat food roll product provided by using the compositions and methods as described herein is provided. The cat food roll products of the present technology have improved shelf-stability, nutritional balance, texture, palatability and reduced shrinkage compared to other analogous products. In some embodiments, the cat food roll products described herein have improved shelf-stability compared to analogous products not prepared using the compositions and methods described herein. In some embodiments, the cat food roll products retain their integrity and texture better than analogous products. In some embodiments, the cat food roll products described herein have improved texture compared to analogous products not prepared using the compositions and methods described herein. In some embodiments, the cat food roll products have improved palatability compared to analogous products not prepared using the compositions and methods described herein.

In some embodiments, the food roll product may be formulated at human-grade standards. In some embodiments, the food roll product may be formulated for pet consumption. In some embodiments, cat food roll product is readily available for consumption of pets such as dogs or cats. In some embodiments, cat food roll product is readily available for consumption of cats. In some embodiments, the food roll product is included in ready-to-eat meal products for cats.

The present invention, thus generally described, will be understood more readily by reference to the following examples, which are provided by way of illustration and are not intended to be limiting of the present invention. The examples are intended to illustrate the various embodiments of the present technology.

### EXAMPLES

The following examples are set forth as illustrative of this invention:

### Example 1

A sausage is generally prepared by grinding the meat or fish protein to a desired consistency either together or separately from the binding agents, mixing the ground mixture with other ingredients and additives to produce a food cat roll composition, forming the composition in to a desired shape, and heating the sausage to a desired temperature and for a suitable period of time to cook the raw meat or fish protein.

A chicken flavored cat food roll product was prepared utilizing the following ingredients: (GFCCK-14)

| Ingredient | % wt |
|---|---|
| Chicken liver and hearts | 29.00 |
| Chicken, MD | 14.50 |
| Chickpeas | 14.50 |
| Pea Protein 70 | 14.50 |
| Sugar | 14.00 |
| Tapioca | 3.05 |
| Egg, Whole Liquid | 2.50 |
| Chicken fat | 2.00 |
| Sea salt | 1.00 |
| Cheese Powder | 1.00 |
| Flaxseed | 0.41 |
| Citric Acid | 0.40 |
| Liquid Smoke | 0.40 |
| Dandelion Greens, dried | 0.05 |
| Cat Premix DSM NP25119 | 0.05 |
| Mixed Tocopherols | 0.0300 |
| Green Lip Mussel Powder | 0.0100 |
| Water | q.s. |

7.25 pounds chicken liver and hearts were added to 3.6 pounds of chicken meat. The chicken mixture is ground by passing through a ¼″ plate to produce a ground chicken mixture having the desired size and binding quality. After grinding the remaining ingredients are added to the mixture. The mixture was then completely mixed and added into a Dick stuffer equipped with an exit horn with a ½″ diameter and 12″ long. Sausages of the composition were extruded into 9″ long plastic type casings. The casings were put through a hot water bath operating at a temperature of 200° F. with and kept there for 120 min. The sausages were tested for moisture content and were at a shelf-stable moisture level of about 38%.

The product was tested on a 20 cat test colony and showed excellent palatability. The product was tested for microbial growth using a bacterial challenge test over a period of 18 months. The sausages showed no substantial increase in microbial activity for a period of 18 months.

### Example 2

A chicken flavored cat treat was prepared utilizing the method of Example 1, but varying the ingredients to include palatability enhancer. The following ingredients were used: (GFCCK-13)

| Ingredient | % wt |
|---|---|
| Chicken Liver and hearts | 29.00 |
| Chicken, MD | 14.50 |
| Chickpeas | 14.50 |
| Pea Protein 70 | 14.50 |
| Sugar | 14.00 |
| Tapioca | 3.05 |
| Pal Enhancer AFB CC716 | 2.60 |
| Egg, Whole Liquid | 2.50 |
| Chicken fat | 2.00 |
| Sea salt | 1.00 |
| Cheese Powder | 1.00 |
| Flaxseed | 0.41 |
| Citric Acid | 0.40 |
| Liquid Smoke | 0.40 |
| Dandelion Greens, dried | 0.05 |
| Cat Premix DSM NP25119 | 0.05 |
| Mixed Tocopherols | 0.0300 |
| Green Lip Mussel Powder | 0.0100 |
| Water | q.s. |

The product was tested on a 20 cat test colony and showed excellent palatability. The product was tested for microbial growth using a bacterial challenge test over a period of 18 months. The sausages showed no substantial microbial activity for a period of 18 months.

### Example 3

A chicken flavored cat treat was prepared utilizing the method of Example 1, but varying the ingredients to include different oil. The following ingredients were used: (GFCCK-11)

| Ingredient | % wt |
|---|---|
| Chicken Liver and hearts | 29.00 |
| Chicken, MD | 14.50 |
| Chickpeas | 14.50 |
| Pea Protein 70 | 14.50 |
| Sugar | 14.00 |
| Tapioca | 3.0 |
| Egg, Whole Liquid | 2.50 |
| Pal Enhancer AFB CC716 | 2.50 |
| Sunflower Oil | 2.00 |
| Sea salt | 1.00 |
| Cheese Powder | 1.00 |
| Citric Acid | 0.50 |
| Flaxseed | 0.41 |
| Liquid Smoke | 0.40 |
| Dandelion Greens, dried | 0.05 |
| Cat Premix DSM NP24975 | 0.05 |
| Mixed Tocopherols | 0.0400 |
| Green Lip Mussel Powder | 0.0100 |
| Water | q.s. |

The product was tested on a 20 cat test colony and showed excellent palatability. The product was tested for microbial growth using a bacterial challenge test over a period of 18 months. The sausages showed no substantial microbial activity for a period of 18 months.

### Example 4

A chicken flavored cat treat was prepared utilizing the method of Example 1, but varying the ingredients to include plant proteins. The following ingredients were used: (GFCCK-3)

| Ingredient | % wt |
|---|---|
| Chicken, MD | 37.50 |
| Chicken Liver and hearts | 12.50 |
| Sugar | 15.50 |
| Pea Protein 70 | 9.00 |
| Egg, Spray Dried | 6.00 |
| Premix 5 | 5.00 |
| Chicken Fat | 4.00 |
| Pal Enhancer SPF C'Sens 13-L Cat | 2.70 |
| Fish Protein Special G | 1.86 |
| Sea salt | 1.00 |
| Pal Enhancer SPF 11P Cat | 1.00 |
| Anchovy paste | 0.50 |
| Vegetable Oil | 0.50 |
| Spinach, Dried | 0.50 |
| Citric Acid | 0.50 |
| Liquid Smoke | 0.40 |
| Dicalcium Phosphate | 0.40 |
| Lactic acid, 88% | 0.30 |
| Cheese Powder | 0.25 |
| Dandelion Greens, dried | 0.25 |
| Tetrasodium Pyrophosphate | 0.20 |
| Xylose | 0.10 |
| Mixed Tocopherols | 0.0400 |
| Taurine | 0.0005 |

The product was tested on a 20 cat test colony and showed excellent palatability. The product was tested for microbial growth using a bacterial challenge test over a period of 18 months. The sausages showed no substantial microbial activity for a period of 18 months.

### Example 5

A fish flavored cat treat was prepared using the following ingredients: (CF-5)

| Ingredient | % wt |
|---|---|
| Fresh catfish | 46.90 |
| Sugar | 15.50 |
| Pea Protein 70 | 7.88 |
| Egg, Spray Dried | 6.00 |
| Premix 5 | 5.50 |
| Chicken Fat | 5.00 |
| Pal Enhancer SPF C'Sens 13-L Cat | 3.00 |
| Fish Protein Special G | 3.00 |
| Sea salt | 1.20 |
| Anchovy paste | 0.50 |
| Pal Enhancer SPF 11P Cat | 1.00 |
| Water | 1.00 |
| Vegetable Oil | 0.50 |
| Spinach, Dried | 0.50 |
| Cheese Powder | 0.25 |
| Citric Acid | 0.50 |
| Celery powder | 0.25 |
| Liquid Smoke | 0.40 |
| Calcium Carbonate | 0.40 |
| Lactic acid, 88% | 0.30 |
| Tetrasodium Pyrophosphate | 0.28 |
| Mixed Tocopherols | 0.04 |
| Xylose | 0.10 |

1.88 pounds fresh catfish is ground by passing through ¼″ plate to produce a ground fish mixture having the desired size and binding quality. After grinding the remaining ingredients are added to the mixture. The resulting mixture was thoroughly mixed and added into a Vmag stuffer equipped with a horn ⅝″ in diameter and 2′ long. Sausages of the composition were extruded into 9″ long multi wall composition type casings. The casings were put through a hot water bath operating at a temperature of 210° F. with and kept there for 90 min. The sausages were tested for moisture content and were at a shelf-stable moisture level of 42%.

The product was tested on a 20 cat test colony and showed excellent palatability. The product was tested for microbial growth using bacterial challenge test over a period of 18 months. The sausages showed no substantial microbial activity for a period of 18 months.

### Example 6

A fish flavored cat treat was prepared utilizing the method of Example 5, but using Mackerel instead of Catfish. The following ingredients were used: (CF-4)

| Ingredient | % wt |
|---|---|
| Canned Mackerel | 47.53 |
| Sugar | 15.50 |
| Pea Protein 70 | 7.88 |
| Egg, Spray Dried | 7.00 |
| Premix 5 | 5.50 |
| Chicken Fat | 5.00 |
| Pal Enhancer SPF C'Sens 13L | 3.00 |
| Pork Cat | |
| Fish Protein Special G | 2.00 |
| Sea salt | 1.20 |
| Pal Enhancer SPF 11P Cat | 1.00 |
| Water | 1.00 |
| Vegetable Oil | 0.50 |
| Spinach, Dried | 0.50 |
| Green Lip Mussel Powder | 0.10 |
| Citric Acid | 0.50 |
| Celery powder | 0.25 |
| Liquid Smoke | 0.40 |
| Calcium Carbonate | 0.40 |
| Lactic acid, 88% | 0.30 |
| Tetrasodium Pyrophosphate | 0.30 |
| Mixed Tocopherols | 0.0400 |
| Xylose | 0.10 |

The product was tested on a 20 cat test colony and showed excellent palatability. The product was tested for microbial growth using bacterial challenge test over a period of 18 months. The sausages showed no substantial microbial activity for a period of 18 months.

### Example 7

Storage Stability Test The product was tested for microbial stability using the following method. The product of Example 3 (GFCCK-11 formula) was inoculated with Geobacillus stearothermophilus (Microbiologics lot #872-105-4). An initial sample was collected (Raw product), the remaining product was filled into casings and thermally processed for 90 minutes at 200° F. The product was tested after cooking and every three months for 18 months.

The Raw inoculated product showed; APC TNTC, Salmonella Negative, Coliforms, TNTC. After cooking, and all subsequent samples showed; APC-<250 CFU/g, Salmonella-Negative, Coliforms−<10 CFU/g, Anaerobic plate count-0 cfu/g.

It is to be understood that while the invention has been described in conjunction with the above embodiments, that the foregoing description and examples are intended to illustrate and not limit the scope of the invention. Other aspects, advantages and modifications within the scope of the invention will be apparent to those skilled in the art to which the invention pertains.

What is claimed is:

1. A cat food roll composition comprising:
about 5 wt % to about 90 wt % of an animal protein source;
about 0 wt % to about 40 wt % of a plant protein source;
about 5 wt % to about 50 wt % of a binding agent; and
optionally one or more food grade additives selected from the group consisting of palatability enhancers, humectants, antioxidants, preservatives, fats, and combinations thereof.

2. The cat food roll composition of claim 1, wherein the animal protein source is selected from the group consisting of meat protein, fish protein, egg protein and milk protein, and combinations thereof.

3. The cat food roll composition of claim 2, wherein the meat protein source is selected from the group consisting of beef liver, deboned chicken, chicken liver, chicken heart, and combinations thereof.

4. The cat food roll composition of claim 2, wherein the fish protein source is selected from the group consisting of mackerel, catfish, tuna, tilapia, mussel powder, fish protein powder, and combinations thereof.

5. The cat food roll composition of claim 2, wherein the egg protein source is selected from spray dried eggs, frozen egg whites or a combination thereof.

6. The cat food roll composition of claim 2, wherein the milk protein source comprises cheese powder.

7. The cat food roll composition of claim 2, wherein the plant protein source is selected from the group consisting of dehydrated peas, dehydrated carrots, dried spinach, dandelion greens, flax seeds, and combinations thereof.

8. The cat food roll composition of claim 1, wherein the binding agent is selected from the group consisting of chickpeas, pea protein, pea flour, potato flakes, tapioca, and combinations thereof.

9. The cat food roll composition of claim 1, wherein the composition comprises from about 15 wt % to about 85 wt % of animal protein source, about 0.1 wt % to about 20 wt % of plant protein source and about 5 wt % to about 40 wt % of binding agent.

10. The cat food roll composition of claim 9, further comprising about 1% to about 5% by weight of palatability enhancer, about 5% to about 30% by weight of sugar, about 0.01% to about 0.5% by weight of antioxidant, and about 0.1% to about 5% by weight of fat.

11. A cat food roll product prepared from the cat food roll composition of claim 1.

12. A method of making a cat food roll product, the method comprising combining animal protein, plant protein and binding agent, and optionally one or more food grade additives to form a cat food roll composition and processing the composition to form a cat food roll product.

13. The method of claim 12, wherein the processing comprises forming the composition in to a desired shape; sealing the shaped composition; and heat processing the sealed composition for a period of time sufficient to cook the protein.

14. The method of claim 12, wherein the forming comprises extruding the composition to a roll or shaping the composition in to a patty.

15. The method of claim 12, wherein the sealing comprises forming a hermetically sealed wrapping around the shaped composition.

16. The method of claim 12, wherein the one or more food grade additives are selected from the group consisting of palatability enhancers, humectants, antioxidants, preservatives, fats, and combinations thereof.

17. The method of claim 12, wherein the heat processing comprises cooking the composition to an internal temperature of about 170° F. to about 212° F.

18. The method of claim 12, wherein the heat processing comprises heating the sealed composition in a water bath maintained at a temperature of about 180° F. to about 250° F.

19. The method of claim 12, wherein the heat processing comprises exposing the sealed composition to hot air until the composition reaches an internal temperature of about 170° F. to about 212° F.

20. The method of claim 12, wherein the method further comprises comminuting the meat protein prior to combining it with the plant protein and binding agent.
